(19) United States
(12) Patent Application Publication
(10) Pub. No.: US 2025/0147185 A1
(43) Pub. Date: May 8, 2025

(54) EXTERNAL ROTATION 3D LIDAR DEVICE AND SIMULTANEOUS LOCALIZATION AND MAPPING (SLAM) METHOD THEREOF

(71) Applicant: BEIJING INSTITUTE OF TECHNOLOGY, Beijing (CN)

(72) Inventors: Hao FANG, Beijing (CN); Haoyu YANG, Beijing (CN); Yiren HAO, Beijing (CN); Aobo WANG, Beijing (CN); Kefan ZHENG, Beijing (CN); Delong WU, Beijing (CN); Bochen XU, Beijing (CN); Shaozhun WEI, Beijing (CN); Qingkai YANG, Beijing (CN)

(73) Assignee: BEIJING INSTITUTE OF TECHNOLOGY, Beijing (CN)

(21) Appl. No.: 18/784,970

(22) Filed: Jul. 26, 2024

(30) Foreign Application Priority Data
Nov. 8, 2023 (CN) 202311477750.3

(51) Int. Cl. G01S 17/89; G01S 7/48; G01S 17/10; G01S 17/86

(52) U.S. Cl. CPC G01S 17/89; G01S 7/4802; G01S 17/10; G01S 17/86

(57) ABSTRACT

An external rotation 3D lidar device and a simultaneous localization and mapping (SLAM) method comprises a 3D hybrid solid-state lidar device that is driven to rotate by an external motor. The device significantly improves the horizontal field of view of the lidar and can be mounted on a ground robot to comprehensively improve its 360-degree environment sensing capabilities. Error-state Kalman filtering and pose graph optimization are combined and the overall framework is divided into two parts: front-end odometry and back-end loop-closure optimization. Therefore, high-frequency odometry that meets the requirements of the robot can be output in real time and cumulative errors can be eliminated through the back-end loop-closure optimization.

### CROSS REFERENCE TO RELATED APPLICATIONS

This application is based upon and claims foreign priority to Chinese Patent Application No. 202311477750.3, filed on Nov. 8, 2023, the entire contents of which are incorporated herein by reference.

### TECHNICAL FIELD

The present disclosure relates to an external rotation 3D lidar device and a SLAM method thereof, and in particular, to an external rotation 3D lidar device and a SLAM method adapted to the device, which belong to the technical field of robotic perception, localization, and mapping.

### BACKGROUND

SLAM, short for simultaneous localization and mapping, is currently a very promising technology in the field of robotic perception, localization, and autonomous navigation. The core significance of this technology is that, a robot in a large-scale unknown environment does not rely on external measurements to determine its position, but relies on its own sensors to determine increments of its position, so that the robot is localized in the environment map and an environment point cloud map is built according to its position and the sensor data at the current position. The technical field of SLAM is mainly divided into laser SLAM, visual SLAM, and multi-sensor fusion SLAM. The laser SLAM technology has been widely used in the fields such as autonomous driving, intelligent robots, 3D reconstruction, and smart cities due to its high localization accuracy, strong robustness, and high mapping quality. Since the cost of the emerging hybrid solid-state lidar is largely reduced, the laser SLAM technology is expected to be more widely used in the future. However, the existing hybrid solid-state lidar, suitable for long-distance detection in an unknown large-scale scene, has a very limited horizontal field of view, which causes problems such as limited sensing capabilities and poor localization effect when the hybrid solid-state lidar is applied to a robot and thus brings great challenges to the existing SLAM algorithm.

Currently, the following solutions are provided for the laser SLAM technology:

Solution 1: “Loam livox: A fast, robust, high-precision LiDAR odometry and mapping package for LiDARs of small FoV” by J. Lin and F. Zhang in 2020 IEEE International Conference on Robotics and Automation (ICRA), Paris, France, 2020, pp. 3126-3131 proposes a Loam livox algorithm which is an application of the LOAM algorithm in hybrid solid-state lidars. Loam livox has two main contributions: One is valid point screening and feature point extraction based on the scanning characteristics of the hybrid solid-state lidar; and the other is iterative pose optimization strategy for continuously correcting the distorted point cloud through iteration. The proposal of this algorithm leads to subsequent adaption of the SLAM algorithm to the hybrid solid-state lidar, but it does not solve the problem of localization deviation caused by limited sensing capabilities of the hybrid solid-state lidar. Besides, this algorithm relies too much on the number of features in the environment and cannot achieve good localization effect in unstructured environments.

Solution 2: “LIO-SAM: Tightly-coupled Lidar Inertial Odometry via Smoothing and Mapping” by T. Shan, B. Englot, D. Meyers, W. Wang, C. Ratti, and D. Rus in 2020 IEEE/RSJ International Conference on Intelligent Robots and Systems (IROS), Las Vegas, NV, USA, 2020, pp. 5135-5142 proposes a LIO-SAM algorithm which tightly couples the lidar odometry and the inertial odometry through graph optimization, making the pose integrated by the odometry more accurate. Meanwhile, the global positioning system (GPS) is used in back-end optimization to constrain some pose nodes and a mapping effect closer to reality is obtained. However, this algorithm is difficult to implement since it needs a 9-axis inertial measurement unit (IMU) for fusion and requires precise calibration between the lidar and the IMU. Besides, this algorithm is inapplicable to robots moving at high speed and problems such as localization failure and map overlapping will occur in the case of high-speed movements.

Solution 3: “FAST-LIO2: Fast Direct LiDAR-Inertial Odometry” by W. Xu, Y. Cai, D. He, J. Lin, and F. Zhang in IEEE Transactions on Robotics, vol. 38, no. 4, pp. 2053-273 August 2022 proposes a FAST-LIO2 algorithm which is a fast and robust lidar-inertial odometry. This algorithm has made two key innovations based on a tightly-coupled iterated Kalman filter: One is to use a direct method without feature extraction to improve the accuracy of the system through subtle features in the environment. The other is to perform map maintenance through an incremental kd-tree, which supports incremental insertion and deletion, maintains dynamic balance of the tree, and ultimately achieves fast and accurate lidar localization. However, the only defect is that this algorithm is just a lidar odometry without back-end optimization, which results in large cumulative errors when the robot is localized in an unknown large-scale scene, and thus the built point cloud map is far from the real scene.

### SUMMARY

To eliminate the defects in the prior art, the present disclosure provides an external rotation 3D lidar device and a SLAM method thereof. The external rotation 3D lidar device and the SLAM method adapted to the device are used to solve the problems such as limited sensing capabilities, large localization errors, and low mapping efficiency when a 3D hybrid solid-state lidar with a small field of view is applied to robots. The device enables the system to achieve 360-degree environment sensing capabilities, and uses the adapted SLAM method to solve the problem of localization deviation caused by the small field of view of the lidar, thereby improving the localization robustness and mapping efficiency of the system.

The present disclosure provides the following technical solutions:

An external rotation 3D lidar device is provided, including a processor (1), a hybrid solid-state lidar (2), a camera (3), a slip ring (4), a coupling (5), a stepper motor (6), a pulse generator (7), buck modules (8), a power distribution board (9), a power supply (10), and a motor drive (11), where
the processor (1) is mounted above the hybrid solid-state lidar (2) and is configured to receive real-time data of the hybrid solid-state lidar (2);
the camera (3) is fixedly mounted on one side of the hybrid solid-state lidar (2) and is configured to record videos;
the stepper motor (6) and the slip ring (4) are both connected to the hybrid solid-state lidar (2) via the coupling (5), that is, the stepper motor (6), the slip ring (4), the coupling (5), and the hybrid solid-state lidar (2) form a rotating mechanism;
the pulse generator (7) is configured to control the motor drive (11) and accordingly control the stepper motor (6);
power provided by the power supply (10) is split by the power distribution board (9) into four paths, two of the four paths being configured for powering the pulse generator (7) and the motor drive (11), and other two of the four paths being configured for powering the processor (1) and the hybrid solid-state lidar (2) through the buck modules (8) and the slip ring (4).

A SLAM method adapted to the external rotation 3D lidar device is provided, including the following steps:
(1) acquiring data of an inertial measurement unit (IMU) and predicting an IMU state according to the data of the IMU to obtain an initial value of the IMU state;
(2) performing a nearest neighbor motion compensation on an original point cloud of the lidar to restore a real scene structure based on the initial value of the IMU state obtained in the step (1);
(3) filtering a point cloud obtained by the nearest neighbor motion compensation in the step (2) to obtain a filtered point cloud;
(4) performing k-nearest neighbor (KNN) search on the filtered point cloud; finding, in a local map, five nearest points to each point in the filtered point cloud for plane fitting; and if plane conditions are satisfied, computing a normal vector to a plane and computing a distance from the point to the plane as a lidar residual;
(5) inputting the lidar residual obtained in the step (4) and the initial value of the IMU state obtained in the step (1) into an error-state iterated Kalman filter, to form a maximum a posteriori probability problem and solve the problem iteratively, where when an update amount is less than a set threshold, iteration convergence occurs and an optimal pose estimate of a current frame is output; and
(6) performing loop-closure frame detection based on the optimal pose estimate obtained in the step (5) and the filtered point cloud obtained in the step (3); performing loop-closure verification after a loop-closure frame is detected, where if a loop-closure is verified, a pose graph optimization is performed and an optimization result is updated into an odometry and a map, and if the loop-closure is invalid, no processing is performed; and outputting a global map when a robot task is completed.

In the step (1), the IMU state is predicted by the following method:
setting state variables to be predicted to:

x=[^{G}p_{I}^{T G}R_{I}^{T G}v_{I}^{T}b_{ω}^{T}bₐ^{T G}g^{T}]^{T}
where ^{G}p_{I}^{T}, ^{G}R_{I}^{T}, and ^{G}v_{I}^{T} respectively represent a position, an attitude, and a velocity of the IMU in a global coordinate system (G), b_{ω}^{T} and bₐ^{T} respectively represent biases in an angular velocity and an acceleration of the IMU, and ^{G}g^{T} represents a gravity vector in the global coordinate system (G);
if noises in a state prediction process are set to 0, a state prediction formula being:

$${\hat{x}}_{m + 1} = {\hat{x}}_{m} ⊕ ( Δ tg ( {\hat{x}}_{m} , {u}_{m} , 0 ) )$$

where \hat{x}ₘ₊₁ represents roughly estimated state variables of an (m+1)^{th} frame of the IMU, \hat{x}ₘ represents roughly estimated state variables of an m^{th} frame of the IMU, ⊕ represents a generalized addition operator, Δt represents a time difference between two adjacent frames of the IMU, and g(\hat{x}ₘ, uₘ, 0) represents an increment function taking the roughly estimated state variables \hat{x}ₘ of the m^{th} frame of the IMU and data uₘ of the m^{th} frame of the IMU as inputs;
propagating a covariance by using an error-state dynamic model:

$${\tilde{x}}_{m + 1} = {x}_{m + 1} ⊖ {\hat{x}}_{m + 1} = ( {x}_{m} ⊕ Δ tg ( {x}_{m} , {u}_{m} , {w}_{m} ) ) ⊖ ( {\hat{x}}_{m} ⊕ Δ tg ( {\hat{x}}_{m} , {u}_{m} , 0 ) )$$

where \tilde{x}ₘ₊₁ represents differences between state variable true values \tilde{x}ₘ₊₁ of the (m+1)^{th} frame of the IMU and the roughly estimated state variables \hat{x}ₘ₊₁ of the (m+1)^{th} frame of the IMU, ⊖ represents a generalized subtraction operator, xₘ represents state variable true values of the m^{th} frame of the IMU, and g(xₘ, uₘ, wₘ) represents an increment function taking the state variable true values xₘ of the m^{th} frame of the IMU, the data uₘ of the m^{th} frame of the IMU, and data noises wₘ of the m^{th} frame of the IMU as inputs;
completing state prediction and obtaining an initial value of pose estimation, that is, the initial value of the IMU state.

In the step (2), the nearest neighbor motion compensation is performed by the following method:
calculating amounts of compensation required for the position, the velocity, and the attitude:

$${}^{{I}_{n}} {\check{p}}_{{I}_{j}} = {}^{{I}_{n}} {\check{p}}_{{I}_{j - 1}} + {}^{{I}_{n}} {\check{v}}_{{I}_{j}} Δ t$$

$${}^{{I}_{n}} {\check{v}}_{{I}_{j}} = {}^{{I}_{n}} {\check{v}}_{{I}_{j - 1}} + {}^{{I}_{n}} {\check{R}}_{{I}_{j}} ( {a}_{{f}_{m - 1}} - {\check{b}}_{{a}_{n}} ) Δ t + {}^{{I}_{n}} {\check{p}}_{n} Δ t$$

$${}^{{I}_{n}} {\check{R}}_{{I}_{j}} = {}^{{I}_{n}} {\check{R}}_{{I}_{j - 1}} Exp {( ( {\hat{b}}_{{ω}_{n}} - {ω}_{{f}_{m - 1}} ) Δ t )}^{τ}$$

where n=1, 2, 3, . . . , K, K representing a total number of frames of the point cloud of the lidar, j=1, 2, 3, . . . , N, N representing a total number of sampling points in each of the frames of the point cloud of the lidar, ^{I}^{ₙ}p̌_{I}_{ⱼ₋₁},^{I}^{ₙ}p̌_{I}_{ⱼ} respectively represent the amounts of the compensation required for the position from a (j−1)^{th} and a j^{th} point to an end of an nth frame of the point cloud in an IMU coordinate system, and Δt represents a time difference from the j^{th} point to a nearest neighbor IMU frame; ^{I}^{ₙ}v̌_{I}_{ⱼ₋₁},^{I}^{ₙ}v̌_{I}_{ⱼ} respectively represent the amounts of the compensation required for the velocity from the (j−1)^{th} and the j^{th} point to the end of the nth frame of the point cloud in the IMU coordinate system, a_{f}_{ₘ₋₁} represents an acceleration input of an (m−1)^{th} frame of the IMU, ban represents an acceleration bias at the end of the n^{th} frame of the point cloud, and ^{I}^{ₙ}ĝₙ represents a gravity vector at the end of the n^{th} frame of the point cloud in the IMU coordinate system; ^{I}^{ₙ}Ř_{I}_{ⱼ₋₁},^{I}^{ₙ}Ř_{I}_{ⱼ} respectively represent the amounts of the compensation required for the attitude from the (j−1)^{th} and the j^{th} point to the end of the n^{th} frame of the point cloud in the IMU coordinate system, bon represents an angular velocity bias at the end of the n^{th} frame of the point cloud, and ω_{f}_{ₘ₋₁} represents an angular velocity input of the (m−1)^{th} frame of the IMU;
a compensated point being:

$${}^{{L}_{n}} {p}_{{h}_{j}} = {}^{I} {T}_{L}^{- 1 {I}_{n}} {\check{T}}_{{I}_{j}} {}^{I} {T}_{L} {}^{{L}_{j}} {p}_{{h}_{j}}$$

where ^{L}^{ₙ}pₕ_{ⱼ} represents a position of the j^{th} point after being compensated to the end of the n^{th} frame of the point cloud, that is, the compensated point, ^{I}^{ₙ}\hat{T}_{I}_{ⱼ} represents an amount of the compensation required from the j^{th} point to the end of the n^{th} frame of the point cloud in the IMU coordinate system, ^{I}T_{L} represents a transformation from a lidar coordinate system to the IMU coordinate system, and ^{L}^{ⱼ}Pₕ_{ⱼ} represents a position of the j^{th} point in the lidar coordinate system, that is, an uncompensated point.

In the step (3), the filtering of the point cloud obtained by the nearest neighbor motion-compensation is conducted by the following method: employing minimal preprocessing without feature extraction and using only two filters, namely, a box filter and a downsampling voxel filter, where the box filter filters out point clouds within a cubic range around a device platform to prevent data of the point clouds from affecting the algorithm processing; and the downsampling voxel filter downsamples collected environment point clouds and sets a voxel grid size for screening to reduce a number of point clouds to be processed while maintaining a main structure of a surrounding environment.

In the step (4), a lidar residual formula is:

$${z}_{j}^{i} = {U}_{j} {(}^{G} {\hat{T}}_{{I}_{n}}^{i} {}^{I} {T}_{L}^{{L}_{n}} {p}_{{h}_{j}} - {}^{G} {q}_{j} )$$

where i=1, 2, 3, . . . , M, M representing a total number of iterations, zⱼⁱ represents a residual of a j^{th} point in an i^{th} iteration, Uⱼ represents a normal vector to a fitted plane, ^{G}\hat{T}_{I}_{ₙ}ⁱ represents a pose of the IMU at an end of an n^{th} frame of the point cloud in the i^{th} iteration, ^{I}T_{L} represents a transformation from a lidar coordinate system to an IMU coordinate system, ^{L}^{ₙ}pₕ_{ⱼ} represents a compensated point, and ^{G}qⱼ represents coordinates of one point in a corresponding plane of the j^{th} point in a global coordinate system.

In the step (5), the maximum a posteriori probability problem is:

$$min ( {\sum }_{j = 1}^{r} {‖ {z}_{j}^{i} + {H}_{j}^{i} {\tilde{x}}_{n}^{i} ‖}_{{R}_{j}^{- 1}}^{2} + {‖ {x}_{n} ⊖ {\hat{x}}_{n} ‖}_{{\hat{P}}_{n}^{- 1}}^{2} )$$

where r represents a number of points in a frame of the filtered point cloud, Hⱼⁱ represents a Jacobian of a residual corresponding to a j^{th} point in an i^{th} iteration, \tilde{x}ₙⁱ represents a state error amount at an end of an n^{th} frame of the point cloud in the i^{th} iteration, Rⱼ represents a measured variance of the original point cloud, xₙ and \hat{x}ₙ respectively represent true values and estimated values of the state variables at the end of the n^{th} frame of the point cloud, and \hat{P}ₙ represents a noise covariance propagated to the end of the n^{th} frame of the point cloud.

In the step (6), the loop-closure frame detection is performed by the following method:
judging similarity between two frames of a laser point cloud by means of depth map matching, generating different feature expressions of each of the two frames of the point cloud based on heights of highest point clouds in different grids, and computing similarity between different feature graphs after feature graph description of each of the two frames of the point cloud is obtained;
a vector distance between two feature graphs being:

$$d ( {c}_{k}^{i} , {c}_{k}^{j} ) = \frac{{c}_{k}^{i} \cdot {c}_{k}^{j}}{‖ {c}_{k}^{i} ‖ ‖ {c}_{k}^{j} ‖}$$

where cₖⁱ and cₖ^{j} respectively represent k^{th} column vectors in the feature graphs i and j;
averaging distances of all the column vectors to obtain a similarity function of the two feature graphs:

$$d ( {F}^{i} , {F}^{j} ) = \frac{1}{{N}_{s}} {\sum }_{k = 1}^{{N}_{s}} ( 1 - \frac{{c}_{k}^{i} \cdot {c}_{k}^{j}}{‖ {c}_{k}^{i} ‖ ‖ {c}_{k}^{j} ‖} )$$

where Fⁱ and F^{j} respectively represent the two feature graphs i and j, and Nₛ represents a number of the column vectors in the feature graphs.

In order to solve a problem of possible phase difference between the two feature graphs, when computing the similarity function, a maximum value of the similarity function of a first one of the feature graphs and a rotated graph of a second one of the feature graphs is used as a final similarity function, that is:

$$D ( {F}^{i} , {F}^{j} ) = {min}_{n ∈ [ N \text{?} ]} d ( {F}^{i} , {F}_{n}^{j} )$$

$$\text{?} \text{indicates text missing or illegible when filed}$$

where Fₙ^{j} represents a new feature graph formed by moving first n columns of the feature graph F^{j} to an end of the feature graph F^{j}, solving the problem of phase difference caused by different viewing angles, and a point cloud frame with a highest similarity exceeding a similarity threshold is used as the loop-closure frame according to a computation result of the final similarity function.

Whether the loop-closure is valid is verified by the following method: when the loop-closure frame is detected by loop-closure detection, performing a nearest neighbor search on a current frame to search for point cloud frames within a range of 12 m, and arranging the point cloud frames according to distances in ascending order, where if an id number of the loop-closure frame is among first 10 numbers, that is, a first condition, and a timestamp of the loop-closure frame is more than 25 s from a current time point, that is, a second condition, the loop-closure frame is considered accurate and pose graph optimization is performed; while if the first condition and the second condition are not satisfied at the same time, the loop-closure frame is considered invalid and no processing is performed.

The pose graph optimization is performed by the following method: solving loop-closure constraints formed after verification, projecting feature points of k point cloud frames near the loop-closure frame into a coordinate system at a time point of the loop-closure frame to obtain a local map in the coordinate system at this time point, and establishing point-to-line residual and point-to-plane residual equations to form a least squares optimization problem regarding relative pose transformation of the current frame in the coordinate system of the loop-closure frame:

$$min ( {\sum }_{k ∈ {ℒ}_{ε}} ρ ( {‖ {r}_{{ℒ}_{s}} ( {p}_{k} , {T}_{i}^{j} ) ‖}_{{p}^{{1}_{k}}}^{2} ) + {\sum }_{k ∈ {ℒ}_{ℋ}} ρ ( {‖ {r}_{{ℒ}_{ℋ}} ( {p}_{k} , {T}_{i}^{j} ) ‖}_{{p}^{{1}_{k}}}^{2} ) )$$

where [symbol] _{ε} and [symbol] respectively represent a number of local line features and a number of local plane features, r [symbol] _{_{ε}}(p_{K}, Tᵢ^{j}) represents point-to-line residual constraints on pose transformation between matched line feature points pₖ and two key frames i and j, [symbol] (pₖ, Tᵢ^{j}) represents point-to-plane residual constraints on pose transformation between matched plane feature points pₖ and the two key frames i and j, and

$$ρ ( {‖ ‖}_{{p}^{{1}_{k}}}^{2} )$$

represents a distance variance; and
solving the least squares optimization problem by using a Levenberg-Marquardt (LM) method to obtain relative pose transformation between the loop-closure frames, updating a pose optimization result into an odometry output, and updating a map based on the pose optimization result to complete an optimization process.

The present disclosure has the following advantages.

The present disclosure provides the external rotation 3D lidar device and the SLAM algorithm adapted to the device to solve the problems such as limited sensing capabilities, large localization errors, and low mapping efficiency when a 3D hybrid solid-state lidar with a small field of view is applied to robots. The present disclosure mainly has the following innovative points:
1. The present disclosure designs a 3D hybrid solid-state lidar device that is driven to rotate by an external motor. The device significantly improves the horizontal field of view of the lidar and can be mounted on a ground robot to comprehensively improve its 360-degree environment sensing capabilities.
2. The present disclosure provides the SLAM algorithm applicable to the device, where the Error-state Kalman filtering and the pose graph optimization are combined and the overall framework is divided into two parts: front-end odometry and back-end loop-closure optimization. Therefore, high-frequency odometry that meets the requirements of the robot can be output in real time and cumulative errors can be eliminated through the back-end loop-closure optimization, so that the odometry result is corrected, the map is further updated, and a high-precision global point cloud map is finally output.
3. It is found by physical testing that this algorithm applied to the device can significantly improve the overall localization accuracy and the mapping quality of the system, and greatly improve the efficiency of environment mapping as compared with the prior art. Therefore, this algorithm is quite suitable for robotic localization and mapping in unknown large-scale scenes.

### BRIEF DESCRIPTION OF THE DRAWINGS

FIG. 1 is a diagram showing electrical connections of a device.

FIG. 2 is a structural diagram of the device in the present disclosure.

FIG. 3 is a schematic flowchart of a method in the present disclosure.

FIG. 4 is a diagram showing the overall effect of a large-scale factory environment in an embodiment.

FIG. 5 is a diagram showing the mapping details of the large-scale factory environment in the embodiment.

In the drawings: 1. processor, 2. hybrid solid-state lidar, 3. camera, 4. slip ring, 5. coupling, 6. stepper motor, 7. pulse generator, 8. buck module, 9. power distribution board, 10. power supply, 11. motor drive.

### DETAILED DESCRIPTION OF THE EMBODIMENTS

The present disclosure will be described in detail below with reference to the accompanying drawings.

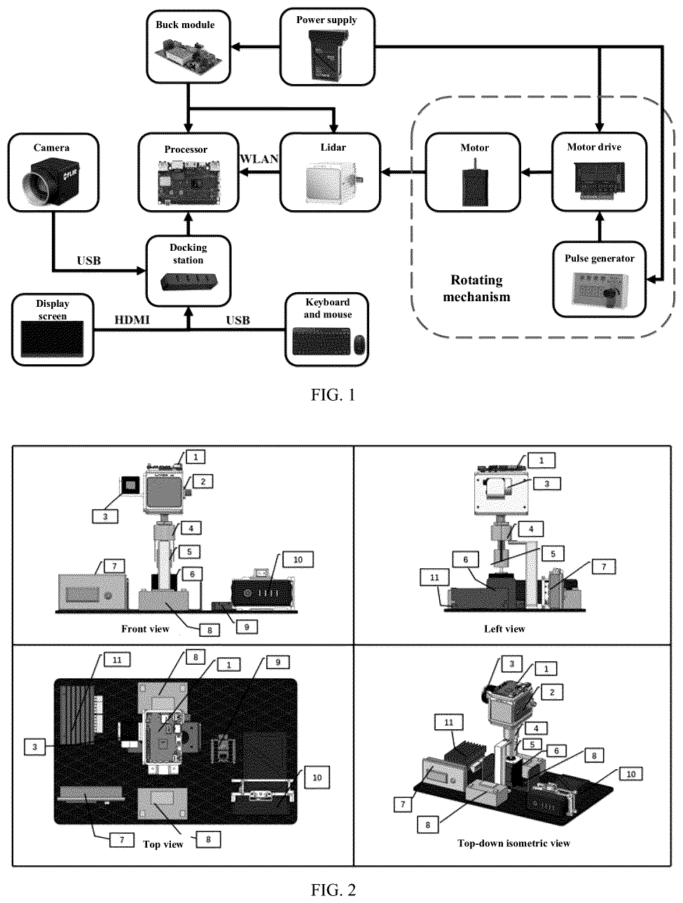

The present disclosure designs and builds an external rotation 3D lidar hardware device, and the electrical connections of the device are shown in FIG. 1. The device is powered by a TB47S power supply. Since both the lidar and the motor consume a large amount of power, the power distribution board is reasonably used to split power into four paths, two for powering the motor drive and the pulse generator and the other two for powering the lidar and the processor through the buck modules and the slip ring structure, which ensures reliable power supply.

The hardware structure of the external rotation 3D lidar device is shown in FIG. 2, and the hardware structure design of the device mainly concerns the following aspects:
1. To ensure that the center of gravity of the device remains in the middle, the rotating mechanism is directly placed at the center of the platform, the motor drive and the pulse generator are located on the left side of the platform, the power supply and the power distribution board are located on the right side of the platform, and the buck modules are symmetrically distributed on the upper and lower sides of the rotating mechanism to keep balance.
2. The slip ring structure is adopted to supply power to the lidar and the processor on the upper layer of the rotating mechanism. The power provided by the power supply is split by the power distribution board and then input into the two buck modules. The outputs of the buck modules are adjusted to required voltages and are connected to the stator end of the slip ring, and the rotor end of the slip ring is connected to the lidar and the processor to complete the whole power supply.
3. To ensure that the processor successfully receives real-time data from the lidar sensor through a network cable, the processor is fixed on the top of the lidar and rotates with the lidar. The processor can also conveniently receive videos recorded by the camera.
4. Regarding the control of the stepper motor, it is rather inconvenient to adjust the speed on a control board since the program needs to be re-burned into the board every time; therefore, the pulse generator is used to conveniently control the motor drive and thus adjust the speed of the motor, which makes the debugging simple.

It should be noted that the timestamp synchronization between the lidar and the IMU has been completed, and the precise calibration parameters between the two sensors are also known.

The present disclosure designs a SLAM method adapted to the external rotation 3D lidar device. Detailed description will be given below from three aspects: overall algorithm framework design, front-end odometry design, and back-end loop-closure optimization design.

### (1) Overall Method Framework Design

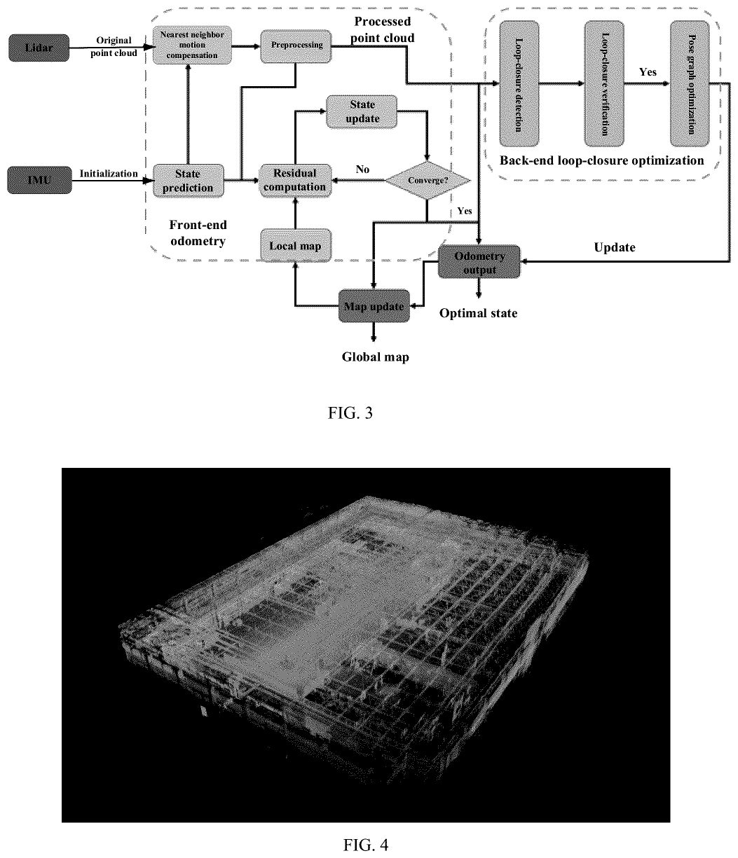

FIG. 3 shows the overall method framework design of the present disclosure. The overall framework is divided into two parts: front-end odometry and back-end loop-closure optimization. As for the algorithm design, the device applying the method is equipped with a high-speed rotating hybrid solid-state lidar, and the optimization-based method is no longer suitable for the front-end odometry due to long computation time in the case of such high-speed rotation. Therefore, error-state iterated Kalman filtering is used at the front end to estimate the state of the system in real time, high-frequency odometry is output, and point cloud data of the current frame is associated to the global map after the optimal pose of the current frame is estimated. However, if only the front-end odometry exists, the algorithm is inapplicable to unknown large-scale scenes because the cumulative errors caused by long-term operation cannot be corrected. Loop-closure optimization is thus designed at the back end. If a loop-closure frame is confirmed after loop-closure detection and loop-closure verification, pose graph optimization is performed to eliminate the cumulative errors, and the optimization result is updated to the odometry and the map.

To sum up, the algorithm framework combines error-state iterated Kalman filtering with pose graph optimization. The specific process is described below: As for the front-end odometry, the algorithm obtains data from the IMU and performs state prediction after initialization. Based on the state prediction result, nearest neighbor motion compensation is performed on the original point cloud of the lidar to restore the real scene structure, and then the point cloud data is preprocessed. Point-to-plane residual computation is carried out on the processed point cloud and the result is input into the iterated Kalman filter together with the initial value of the state prediction. High-frequency odometry output and map update are performed after iteration convergence. As for the back-end loop-closure optimization, the front-end odometry result and the point cloud of the lidar are input into a loop-closure detection module, and loop-closure verification based on Euclidean spatial distances and time intervals is performed after a loop-closure frame is detected. If a loop closure is verified, pose graph optimization is performed and the optimization result is updated to the odometry and the map; otherwise, no processing is performed. When the robot task is completed, the global point cloud map is output.

### (2) Front-End Odometry Design

The framework of the front-end odometry is shown in the left dashed-line box in FIG. 3. Detailed description will be given below according to the process from five aspects: IMU state prediction, nearest neighbor motion compensation on the point cloud, point cloud preprocessing, residual computation, and iterative update.

a. IMU State Prediction

This module has two main functions: One is to provide the system with an initial value of pose estimation and propagate the covariance, and the other is for motion compensation on the point cloud of the lidar.

State variables to be predicted are set to:

x=[^{G}p_{I}^{T G}R_{I}^{T G}v_{I}^{T}b_{ω}^{T}bₐ^{T G}g^{T}]^{T}
where ^{G}p_{I}^{T}, ^{G}R_{I}^{T}, and ^{G}v_{I}^{T} respectively represent a position, an attitude, and a velocity of the IMU in a global coordinate system (G), b_{ω}^{T}, and bₐ^{T} respectively represent biases in an angular velocity and an acceleration of the IMU, and ^{G}g^{T} represents a gravity vector in the global coordinate system (G).

In order to obtain a good initial estimate of the system state and accelerate the overall state estimation, it is necessary to initialize the gravity vector and the bias of the IMU based on the data in the first few seconds after the system is turned on. The state prediction is performed once whenever a frame of the data of the IMU is received after the initialization is completed, and the initial value of state estimation and the covariance to be propagated are obtained.

If the noises in the state prediction process are set to 0, the state prediction formula is:

$${\hat{x}}_{m + 1} = {\hat{x}}_{m} ⊕ ( Δ t g ( {\hat{x}}_{m} , {u}_{m} , 0 ) )$$

where \hat{x}ₘ₊₁ represents roughly estimated state variables of an (m+1)^{th} frame of the IMU, \hat{x}ₘ represents roughly estimated state variables of an m^{th} frame of the IMU, ⊕ represents a generalized addition operator, Δt represents a time difference between two adjacent frames of the IMU, and g(\hat{x}ₘ, uₘ, 0) represents an increment function taking the roughly estimated state variables \hat{x}ₘ of the m^{th} frame of the IMU and data uₘ of the m^{th} frame of the IMU as inputs.

The following error-state dynamic model is used to propagate the covariance:

$${\tilde{x}}_{m + 1} = {x}_{m + 1} ⊖ {\hat{x}}_{m + 1} = ( {x}_{m} ⊕ Δ t g ( {x}_{m} , {u}_{m} , {w}_{m} ) ) ⊖ ( {\hat{x}}_{m} ⊕ Δ t g ( {\hat{x}}_{m} , {u}_{m} , 0 ) )$$

where \tilde{x}ₘ₊₁ represents differences between state variable true values \tilde{x}ₘ₊₁ of the (m+1)^{th} frame of the IMU and the roughly estimated state variables \hat{x}ₘ₊₁ of the (m+1)^{th} frame of the IMU, ⊖ represents a generalized subtraction operator, xₘ represents state variable true values of the m^{th} frame of the IMU, and g(xₘ, uₘ, wₘ) represents an increment function taking the state variable true values xₘ of the m^{th} frame of the IMU, the data uₘ of the m^{th} frame of the IMU, and data noises wₘ of the m^{th} frame of the IMU as inputs.

Till now, the state prediction is completed, and the initial value of pose estimation, that is, the initial value of the IMU state, is obtained.

b. Nearest Neighbor Motion Compensation on the Point Cloud

Since the original point cloud obtained by the lidar is a frame of data accumulated within a period of time based on a sampling frequency, if the carrier performs translational or rotational movement during the acquisition of this frame of data, the coordinate system of the point cloud changes at different time points of this frame of data. If the computation is based on a coordinate system at the same time point, translational distortion and rotational distortion of the point cloud will be caused, the obtained data is inaccurate, and the result of the algorithm is also directly affected.

When the disclosed device is mounted on a ground robot, translational distortion and rotational distortion will occur due to the movement of the robot, and the lidar on the device also rotates at high speed, which largely increases the degree of rotational distortion, resulting in great difference of the point cloud data from the real scene. Therefore, it is critical to perform motion compensation on the point cloud to restore the real scene structure. Based on this, a nearest neighbor motion compensation method is designed. According to the result of IMU state prediction, each point in one frame of the point cloud is allocated between two different frames of data of the IMU by time, and the difference between the timestamp of this point and the timestamps of the two adjacent IMU frames on the left and right sides is calculated. Based on the position, attitude, and velocity of the nearest IMU frame by time, the angular velocity and acceleration of the other IMU frame are taken as inputs to calculate amounts of compensation required from this point to the end of the frame. The amounts of compensation are used for motion compensation to eliminate the motion distortion.

The amounts of compensation required for the position, attitude, and velocity of this point are calculated below (taking the nearest left IMU frame as an example):

$$\begin{matrix}{}^{{I}_{n}} {\check{p}}_{{I}_{j}} = {}^{{I}_{n}} {\check{p}}_{{I}_{j - 1}} + {}^{{I}_{n}} {\check{v}}_{{I}_{j}} Δ t \\ {}^{{I}_{n}} {\check{v}}_{{I}_{j}} = {}^{{I}_{n}} {\check{v}}_{{I}_{j - 1}} + {}^{{I}_{n}} {\check{R}}_{{I}_{j}} ( {a}_{{f}_{m - 1}} - {\hat{b}}_{{a}_{n}} ) Δ t + {}^{{I}_{n}} {\hat{g}}_{n} Δ t \\ {}^{{I}_{n}} {\check{R}}_{{I}_{j}} = {}^{{I}_{n}} {\check{R}}_{{I}_{j - 1}} Exp {( ( {\hat{b}}_{{ω}_{n}} - {ω}_{{f}_{m - 1}} ) Δ t )}^{T}\end{matrix}$$

where n=1, 2, 3, . . . , K, K representing the total number of frames of the point cloud of the lidar, j=1, 2, 3, . . . , N, N representing the total number of sampling points in one frame of the point cloud of the lidar, ^{I}^{ₙ}p̌_{I}_{ⱼ₋₁},^{I}^{ₙ}p̌_{I}_{ⱼ} respectively represent the amounts of the compensation required for the position from the (j−1)^{th} and the j^{th} point to the end of the n^{th} frame of the point cloud in the IMU coordinate system, and Δt represents the time difference from the j^{th} point to the nearest neighbor IMU frame; ^{I}^{ₙ}v̌_{I}_{ⱼ₋₁},^{I}^{ₙ}v̌_{I}_{ⱼ} respectively represent the amounts of the compensation required for the velocity from the (j−1)^{th} and the j^{th} point to the end of the n^{th} frame of the point cloud in the IMU coordinate system, a_{f}_{ₘ₋₁} represents an acceleration input of the (m−1)^{th} frame of the IMU, \hat{b}ₐ_{ₙ} represents an acceleration bias at the end of the n^{th} frame of the point cloud, and ^{I}^{ₙ}ĝₙ represents a gravity vector at the end of the n^{th} frame of the point cloud in the IMU coordinate system; ^{I}^{ₙ}Ř_{I}_{ⱼ₋₁},^{I}^{ₙ}R_{I}_{ⱼ} respectively represent the amounts of the compensation required for the attitude from the (j−1)^{th} and the j^{th} point to the end of the n^{th} frame of the point cloud in the IMU coordinate system, bon represents an angular velocity bias at the end of the n^{th} frame of the point cloud, and ω_{f}_{ₘ₋₁} represents an angular velocity input of the (m−1)^{th} frame of the IMU.

Firstly, the current point is transformed into the IMU coordinate system for motion compensation, and then transformed back to the lidar coordinate system to obtain the compensated point. The compensated point is:

$${}^{{L}_{n}} {p}_{{h}_{j}} = {}^{I} {T}_{L}^{- 1 {I}_{n}} {\check{T}}_{{I}_{j}} {}^{I} {T}_{L} {}^{{L}_{j}} {p}_{{h}_{j}}$$

where ^{L}^{ₙ}pₕ_{ⱼ} represents the position of the j^{th} point after being compensated to the end of the n^{th} frame of the point cloud, that is, the compensated point, ^{I}^{ₙ}Ť_{I}_{ⱼ} represents the amount of compensation required from the j^{th} point to the end of the n^{th} frame of the point cloud in the IMU coordinate system, ^{I}T_{L} represents the transformation from the lidar coordinate system to the IMU coordinate system, and ^{L}^{ⱼ}pₕ_{ⱼ} represents the position of the j^{th} point in the lidar coordinate system, that is, the uncompensated point.
   c. Point Cloud Preprocessing

The point cloud processing is performed by means of feature extraction in the existing algorithms such as loam livox and LIO-SAM, and in this way, the number of points can be largely reduced and less time is required for residual computation. However, since the feature extraction is to extract based on curvature two geometric features, namely, edge points and planar points, it is more suitable for structured environments and fails in the case of unstructured environments with few geometric features. Besides, the feature extraction module is also time-consuming.

In view of the above, the disclosed device employs minimal preprocessing without feature extraction, and uses only two filters, namely, a box filter and a downsampling voxel filter.
1. The box filter filters out point clouds within a cubic range around the device platform to prevent data of the point clouds from affecting the algorithm processing.
2. The downsampling voxel filter downsamples collected environment point clouds and sets the voxel grid size for screening to reduce the number of point clouds to be processed while maintaining the main structure of the surrounding environment.
   d. Residual Computation

Since no feature extraction is performed, the computation and judgment of curvature are omitted. When a new frame of the preprocessed radar point cloud arrives, KNN search is performed on each point to find five nearest points in the local map for plane fitting. If the plane conditions are satisfied, a normal vector to the plane is computed and is combined with the coordinates of the point to compute the distance from the point to the plane as the residual.

The residual computation formula is:

$${z}_{j}^{i} = {U}_{j} {(}^{G} {\hat{T}}_{{I}_{n}}^{i} {}^{I} {T}_{L} {}^{{L}_{n}} {p}_{{h}_{j}} - {}^{G} {q}_{j} )$$

where i=1, 2, 3, . . . , M, M representing the total number of iterations, zⱼⁱ represents the residual of the j^{th} point in the i^{th} iteration, Uⱼ represents a normal vector to the fitted plane, ^{G}T_{I}_{ₙ}ⁱ represents the pose of the IMU at the end of the n^{th} frame of the point cloud in the i^{th} iteration, ^{I}T_{L} represents the transformation from the lidar coordinate system to the IMU coordinate system, ^{L}^{ₙ}pₕ_{ⱼ} represents the compensated point, and ^{G}qⱼ represents the coordinates of one point in the corresponding plane of the j^{th} point in the global coordinate system.
   e. Iterative Update

The obtained lidar residual and the initial value of state prediction are input into the error-state iterated Kalman filter to form a maximum a posteriori probability problem and solve the problem iteratively. When the update amount is less than a set threshold, iteration convergence occurs and an optimal pose estimate of the current frame is output.

The formed maximum a posteriori probability problem is:

$$min ( {\sum }_{j = 1}^{r} {‖ {z}_{j}^{i} + {H}_{j}^{i} {\tilde{x}}_{n}^{i} ‖}_{{R}_{\overline{j}}^{1}}^{2} + {‖ {x}_{n} ⊖ {\hat{x}}_{n} ‖}_{{\hat{P}}_{\overline{n}}^{1}}^{2} )$$

where r represents the number of points in a frame of the filtered point cloud, Hⱼⁱ represents the Jacobian of the residual corresponding to the j^{th} point in the i^{th} iteration, \tilde{x}ₙⁱ represents the state error amount at the end of the n^{th} frame of the point cloud in the i^{th} iteration, Rⱼ represents the measured variance of the original point cloud, xₙ and \hat{x}ₙ respectively represent true values and estimated values of the state variables at the end of the n^{th} frame of the point cloud, and \hat{P}ₙ represents the noise covariance propagated to the end of the n^{th} frame of the point cloud.

### (3) Back-End Loop-Closure Optimization Design

The framework of the back-end loop-closure optimization is shown in the right dashed-line box in FIG. 3. Detailed description will be given below from three aspects: loop-closure detection, loop-closure verification, and pose graph optimization.

a. Loop-Closure Detection

When loop-closure detection is to be performed on the laser point cloud, since laser cannot extract features and descriptors that are as unique as vision, the similarity between two frames of the laser point cloud is judged by means of depth map matching (SCAN CONTEXT). Different feature expressions of each frame of the point cloud are generated based on heights of the highest point clouds in different grids. The similarity between different feature graphs is computed after the feature graph description of each frame of the point cloud is obtained.

The vector distance between the two frames of the feature graphs is:

$$d ( {c}_{k}^{i} , {c}_{k}^{j} ) = \frac{{c}_{k}^{i} \cdot {c}_{k}^{j}}{‖ {c}_{k}^{i} ‖ ‖ {c}_{k}^{j} ‖}$$

where cₖⁱ and cₖ^{j} respectively represent the k^{th} column vectors in the feature graphs i and j.

The distances of all the column vectors are averaged to obtain a similarity function of the two feature graphs:

$$d ( {F}^{i} , {F}^{j} ) = \frac{1}{{N}_{s}} {\sum }_{k = 1}^{{N}_{s}} ( 1 - \frac{{c}_{k}^{i} \cdot {c}_{k}^{j}}{‖ {c}_{k}^{i} ‖ ‖ {c}_{k}^{j} ‖} )$$

where Fⁱ and Fⁱ respectively represent the two feature graphs i and j, and Nₛ represents the number of the column vectors in the feature graphs.

In order to solve the problem of possible phase difference between the two feature graphs, when computing the similarity function, the maximum value of the similarity function of the first feature graph and a rotated graph of the second feature graph is used as the final similarity function, that is:

$$D ( {F}^{i} , {F}^{j} ) = {min}_{n ∈ [ N \text{?} ]} d ( {F}^{i} , {F}_{n}^{j} )$$

$$\text{?} \text{indicates text missing or illegible when filed}$$

where Fₙ^{j} represents a new feature graph formed by moving the first n columns of the feature graph F^{j} to the end of the feature graph, solving the problem of phase difference caused by different viewing angles, and a point cloud frame with a highest similarity and exceeding a similarity threshold is used as a loop-closure frame according to a computation result of the similarity function.
   b. Loop-Closure Verification

Since the purpose of loop-closure optimization is to make the localization result more accurate, the accuracy of loop-closure detection is very important. If an error loop-closure is detected and the pose graph optimization is performed, the localization result will become worse and the final accuracy is greatly affected.

Therefore, loop-closure verification is designed to ensure the accuracy of the loop-closure. Whether a loop-closure is valid is verified by the following method: When a loop-closure frame is detected by loop-closure detection, a nearest neighbor search is performed on the current frame to search for point cloud frames within a range of 12 m, and the point cloud frames are arranged according to distances in ascending order. If the id number of the loop-closure frame is among the first 10 numbers, that is, a first condition and the timestamp of the loop-closure frame is more than 25 s from the current time point, that is, a second condition, the loop-closure frame is considered accurate and the pose graph optimization is performed. If the two conditions are not satisfied at the same time, the loop-closure frame is considered invalid and no processing is performed. In this way, the accuracy of the loop-closure can be greatly improved and the accuracy of the optimization result is ensured.

c. Pose Graph Optimization

The process of pose graph optimization is mainly as follows: The loop-closure constraints formed after verification are solved. The feature points of k point cloud frames near the loop-closure frame are projected into the coordinate system at a time point of the loop-closure frame to obtain a local map in the coordinate system at this time point. The point-to-line residual and point-to-plane residual equations are established to form a least squares optimization problem regarding relative pose transformation of the current frame in the coordinate system of the loop-closure frame:

$$min ( {\sum }_{k ∈ {ℒ}_{ε}} ρ ( {‖ {r}_{{ℒ}_{s}} ( {p}_{k} , {T}_{i}^{j} ) ‖}_{{p}^{{1}_{k}}}^{2} ) + {\sum }_{k ∈ {ℒ}_{ℋ}} ρ ( {‖ {r}_{{ℒ}_{ℋ}} ( {p}_{k} , {T}_{i}^{j} ) ‖}_{{p}^{{1}_{k}}}^{2} ) )$$

where [symbol] _{g} and [symbol] respectively represent the number of local line features and the number of local plane features, r [symbol] _{_{ε}}(pₖ, Tᵢ^{j}) represents point-to-line residual constraints on pose transformation between the matched line feature points pₖ and the two key frames i and j, [symbol] (p_{K}, Tᵢ^{j}) represents point-to-plane residual constraints on pose transformation between the matched plane feature points pₖ and the two key frames i and j, and

$$ρ ( {‖ ‖}_{{p}^{{1}_{k}}}^{2} )$$

represents a distance variance.

This problem is solved by using an LM method to obtain relative pose transformation between the two loop-closure frames. The pose optimization result is updated into the odometry output, and the map is updated based on the pose optimization result to complete the optimization process.

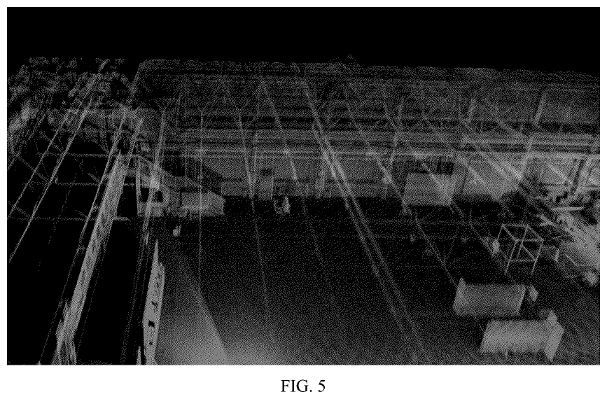

Finally, the algorithm is applied to a designed external rotation 3D lidar, and the lidar is mounted on a ground unmanned vehicle platform for localization and mapping testing in a large-scale factory environment. FIG. 4 shows the mapping result of the entire large-scale factory environment. The localization accuracy is high and the overall effect is excellent. Moreover, the mapping efficiency during the movement of the ground unmanned vehicle platform is very high and a point cloud map of the surrounding environment can be quickly built through high-speed rotation. FIG. 5 shows the mapping details, by the SLAM method, of the factory after being zoomed in, where the walls are flat, the mapping is dense and of high quality, and the effect is stunning.

The above descriptions are merely preferred embodiments of the present disclosure and are not intended to limit the protection scope of the present disclosure. Any modification, equivalent replacement, and improvement made within the spirit and principle of the present disclosure shall fall within the protection scope of the present disclosure.

1. An external rotation 3D lidar device, comprising:
a processor,
a hybrid solid-state lidar,
a camera,
a slip ring,
a coupling,
a stepper motor,
a pulse generator,
buck modules,
a power distribution board,
a power supply, and
a motor drive, wherein
the processor is mounted above the hybrid solid-state lidar and is configured to receive real-time data of the hybrid solid-state lidar;
the camera is fixedly mounted on one side of the hybrid solid-state lidar and is configured to record videos;
the stepper motor and the slip ring are both connected to the hybrid solid-state lidar via the coupling, that is, the stepper motor, the slip ring, the coupling, and the hybrid solid-state lidar form a rotating mechanism;
the pulse generator is configured to control the motor drive and accordingly control the stepper motor;
power provided by the power supply is split by the power distribution board into four paths, two of the four paths being configured for powering the pulse generator and the motor drive, and other two of the four paths being configured for powering the processor and the hybrid solid-state lidar through the buck modules and the slip ring.

2. A simultaneous localization and mapping (SLAM) method adapted to the external rotation 3D lidar device according to claim 1, comprising:
(1) acquiring data of an inertial measurement unit (IMU) and predicting an IMU state according to the data of the IMU to obtain an initial value of the IMU state;
(2) performing a nearest neighbor motion compensation on an original point cloud of the hybrid solid-state lidar to restore a real scene structure based on the initial value of the IMU state obtained in the step (1);
(3) filtering a point cloud obtained by the nearest neighbor motion compensation in the step (2) to obtain a filtered point cloud;
(4) performing k-nearest neighbor (KNN) search on the filtered point cloud; finding, in a local map, five nearest points to each point in the filtered point cloud for plane fitting; and if plane conditions are satisfied, computing a normal vector to a plane and computing a distance from the each point to the plane as a lidar residual;
(5) inputting the lidar residual obtained in the step (4) and the initial value of the IMU state obtained in the step (1) into an error-state iterated Kalman filter, to form a maximum a posteriori probability problem and solve the problem iteratively, wherein when an update amount is less than a set threshold, iteration convergence occurs and an optimal pose estimate of a current frame is output; and
(6) performing loop-closure frame detection based on the optimal pose estimate obtained in the step (5) and the filtered point cloud obtained in the step (3); performing loop-closure verification after a loop-closure frame is detected, wherein if a loop-closure is verified, a pose graph optimization is performed and an optimization result is updated into an odometry and a map, and if the loop-closure is invalid, no processing is performed; and outputting a global map when a robot task is completed.

3. The SLAM method adapted to the external rotation 3D lidar device according to claim 2, wherein:
in the step (1), the IMU state is predicted by the following method:
setting state variables to be predicted to:
x=[^{G}p_{I}^{T G}R_{I}^{T G}v_{I}^{T}b_{ω}^{T}bₐ^{T G}g^{T}]^{T}
wherein ^{G}p_{I}^{T}, ^{G}R_{I}^{T}, and ^{G}v_{I}^{T} respectively represent a position, an attitude, and a velocity of the IMU in a global coordinate system G, b_{ω}^{T} and bₐ^{T} respectively represent biases in an angular velocity and an acceleration of the IMU, and ^{G}g^{T} represents a gravity vector in the global coordinate system G;
if noises in a state prediction process are set to 0, a state prediction formula being:
$${\hat{x}}_{m + 1} = {\hat{x}}_{m} ⊕ ( Δ tg ( {\hat{x}}_{m} , {u}_{m} , 0 ) )$$
wherein \hat{x}ₘ₊₁ represents roughly estimated state variables of an (m+1)^{th} frame of the IMU, \hat{x}ₘ represents roughly estimated state variables of an m^{th} frame of the IMU, ⊕ represents a generalized addition operator, Δt represents a time difference between two adjacent frames of the IMU, and g(\hat{x}m, uₘ, 0) represents an increment function taking the roughly estimated state variables \hat{x}ₘ of the m^{th} frame of the IMU and data uₘ of the m^{th} frame of the IMU as inputs;
propagating a covariance by using an error-state dynamic model:
$${\tilde{x}}_{m + 1} = {x}_{m + 1} ⊖ {\hat{x}}_{m + 1} = ( {x}_{m} ⊕ Δ tg ( {x}_{m} , {u}_{m} , {w}_{m} ) ) ⊖ ( {\hat{x}}_{m} ⊕ Δ tg ( {\hat{x}}_{m} , {u}_{m} , 0 ) )$$
wherein \tilde{x}ₘ₊₁ represents differences between state variable true values \tilde{x}ₘ₊₁ of the (m+1)^{th} frame of the IMU and the roughly estimated state variables \hat{x}ₘ₊₁ of the (m+1)^{th} frame of the IMU, ⊕ represents a generalized subtraction operator, xₘ represents state variable true values of the m^{th} frame of the IMU, and g(xₘ, uₘ, wₘ) represents an increment function taking the state variable true values xₘ of the m^{th} frame of the IMU, the data uₘ of the m^{th} frame of the IMU, and data noises wₘ of the m^{th} frame of the IMU as inputs;
completing state prediction and obtaining an initial value of pose estimation, that is, the initial value of the IMU state.

4. The SLAM method adapted to the external rotation 3D lidar device according to claim 2, wherein:
in the step (2), the nearest neighbor motion compensation is performed by the following method:
calculating amounts of compensation required for the position, the velocity, and the attitude:
$${}^{{I}_{n}} {\check{p}}_{{I}_{j}} = {}^{{I}_{n}} {\check{p}}_{j - 1} + {}^{{I}_{n}} {\check{v}}_{{I}_{j}} Δ t$$
$${}^{{I}_{n}} {\check{v}}_{{I}_{j}} = {}^{{I}_{n}} {\check{v}}_{{I}_{j - 1}} + {}^{{I}_{n}} {\check{R}}_{{I}_{j}} ( {a}_{{f}_{m - 1}} - {\hat{b}}_{{a}_{n}} ) Δ t + {}^{{I}_{n}} {\hat{g}}_{n} Δ t$$
$${}^{{I}_{n}} {\check{R}}_{{I}_{j}} = {}^{{I}_{n}} {\check{R}}_{{I}_{j - 1}} Exp {( ( {\hat{b}}_{{ω}_{n}} - {ω}_{{f}_{m - 1}} ) Δ t )}^{T}$$
wherein n=1, 2, 3, . . . , K, K representing a total number of frames of the point cloud of the lidar, j=1, 2, 3, . . . , N, N representing a total number of sampling points in each of the frames of the point cloud of the lidar, ^{I}^{ₙ}p̌_{I}_{ⱼ₋₁},^{I}^{ₙ}p̌_{I}_{ⱼ} respectively represent the amounts of the compensation required for the position from a (j−1)^{th} and a j^{th} point to an end of an nth frame of the point cloud in an IMU coordinate system, and Δt represents a time difference from the j^{th} point to a nearest neighbor IMU frame; ^{I}^{ₙ}v̌_{I}_{ⱼ₋₁},^{I}^{ₙ}v̌_{I}_{ⱼ} respectively represent the amounts of the compensation required for the velocity from the (j−1)^{th} and the j^{th} point to the end of the nth frame of the point cloud in the IMU coordinate system, a_{f}_{ₘ₋₁} represents an acceleration input of an (m−1)^{th} frame of the IMU, ban represents an acceleration bias at the end of the n^{th} frame of the point cloud, and ^{I}^{ₙ}ĝₙ represents a gravity vector at the end of the n^{th} frame of the point cloud in the IMU coordinate system; ^{I}^{ₙ}Ř_{I}_{ⱼ₋₁},^{I}^{ₙ}Ř_{I}_{ⱼ} respectively represent the amounts of the compensation required for the attitude from the (j−1)^{th} and the j^{th} point to the end of the n^{th} frame of the point cloud in the IMU coordinate system, bon represents an angular velocity bias at the end of the n^{th} frame of the point cloud, and ω_{f}_{ₘ₋₁} represents an angular velocity input of the (m−1)^{th} frame of the IMU;
a compensated point being:
$${}^{{L}_{n}} {p}_{{h}_{j}} = {}^{I} {T}_{L}^{- 1} {}^{{I}_{n}} {\check{T}}_{{I}_{j}}^{I} {T}_{L}^{{L}_{j}} {p}_{{h}_{j}}$$
where ^{L}^{ₙ}pₕ_{ⱼ} represents a position of the j^{th} point after being compensated to the end of the n^{th} frame of the point cloud, that is, the compensated point, ^{I}^{ₙ}\hat{T}_{I}_{ⱼ} represents an amount of the compensation required from the j^{th} point to the end of the n^{th} frame of the point cloud in the IMU coordinate system, ^{I}T_{L} represents a transformation from a lidar coordinate system to the IMU coordinate system, and ^{L}^{ⱼ}Pₕ_{ⱼ} represents a position of the j^{th} point in the lidar coordinate system, that is, an uncompensated point.

5. The SLAM method adapted to the external rotation 3D lidar device according to claim 4, wherein:
in the step (3), the filtering of the point cloud obtained by the nearest neighbor motion-compensation is conducted by the following method:
employing minimal preprocessing with two filters, namely, a box filter and a downsampling voxel filter, wherein the box filter filters out point clouds within a cubic range around a device platform; and the downsampling voxel filter downsamples collected environment point clouds and sets a voxel grid size for screening to reduce a number of point clouds to be processed while maintaining a main structure of a surrounding environment.

6. The SLAM method adapted to the external rotation 3D lidar device according to claim 2, wherein:
in the step (4), a lidar residual formula is:
$${z}_{j}^{i} = {U}_{j} {(}^{G} {\hat{T}}_{{I}_{n}}^{i} {}^{I} {T}_{L}^{{}^{{L}_{n}}} {p}_{{h}_{j}} - {}^{G} {q}_{j} )$$
wherein i=1, 2, 3, . . . , M, M representing a total number of iterations, zⱼⁱ represents a residual of a j^{th} point in an i^{th} iteration, Uᵢ represents a normal vector to a fitted plane, ^{G}\hat{T}_{I}_{ₙ}ⁱ represents a pose of the IMU at an end of an n^{th} frame of the point cloud in the i^{th} iteration, ^{I}T_{L} represents a transformation from a lidar coordinate system to an IMU coordinate system, ^{L}^{ₙ}pₕ_{ⱼ} represents a compensated point, and ^{G}qⱼ represents coordinates of one point in a corresponding plane of the j^{th} point in a global coordinate system.

7. The SLAM method adapted to the external rotation 3D lidar device according to claim 2, wherein:
in the step (5), the maximum a posteriori probability problem is:
$$min ( {\sum }_{j = 1}^{r} {‖ {z}_{j}^{i} + {H}_{j}^{i} {\tilde{x}}_{n}^{i} ‖}_{{R}_{j}^{- 1}}^{2} + {‖ {x}_{n} ⊖ {\hat{x}}_{n} ‖}_{{\hat{P}}_{n}^{- 1}}^{2} )$$
wherein r represents a number of points in a frame of the filtered point cloud, Hⱼⁱ represents a Jacobian of a residual corresponding to a j^{th} point in an i^{th} iteration, \hat{x}ₙⁱ represents a state error amount at an end of an n^{th} frame of the point cloud in the i^{th} iteration, Rⱼ represents a measured variance of the original point cloud, xₙ and \hat{x}ₙ respectively represent true values and estimated values of the state variables at the end of the n^{th} frame of the point cloud, and \hat{P}ₙ represents a noise covariance propagated to the end of the n^{th} frame of the point cloud.

8. The SLAM method adapted to the external rotation 3D lidar device according to claim 2, wherein:
in the step (6), the loop-closure frame detection is performed by the following method:
judging similarity between two frames of a laser point cloud by means of depth map matching, generating different feature expressions for the two frames of the point cloud based on heights of highest point clouds in different grids, and computing similarity between different feature graphs after feature graph description of each of the two frames of the point cloud is obtained;
a vector distance between two feature graphs being:
$$d ( {c}_{k}^{i} , {c}_{k}^{j} ) = \frac{{c}_{k}^{i} \cdot {c}_{k}^{j}}{‖ {c}_{k}^{i} ‖ ‖ {c}_{k}^{j} ‖}$$
wherein cₖⁱ and cₖ^{j} respectively represent k^{th} column vectors in the feature graphs i and j;
averaging distances of all the column vectors to obtain a similarity function of the two feature graphs:
$$d ( {F}^{i} , {F}^{j} ) = \frac{1}{{N}_{s}} {\sum }_{k = 1}^{{N}_{s}} ( 1 - \frac{{c}_{k}^{i} \cdot {c}_{k}^{j}}{‖ {c}_{k}^{i} ‖ ‖ {c}_{k}^{j} ‖} )$$
wherein Fⁱ and F^{j} respectively represent the two feature graphs i and j, and Nₛ represents a number of the column vectors in the feature graphs;
using a maximum value of the similarity function of a first one of the feature graphs and a rotated graph of a second one of the feature graphs as a final similarity function, that is:
$$D ( {F}^{i} , {F}^{j} ) = {min}_{n ∈ [ {N}_{s} ]} d ( {F}^{i} , {F}_{n}^{j} )$$
wherein Fₙ^{j} represents a new feature graph formed by moving first n columns of the feature graph F^{j} to an end of the feature graph F^{j}, and a point cloud frame with a highest similarity exceeding a similarity threshold is used as the loop-closure frame according to a computation result of the final similarity function.

9. The SLAM method adapted to the external rotation 3D lidar device according to claim 8, wherein:
whether the loop-closure is valid is verified by the following method: when the loop-closure frame is detected by loop-closure detection, performing a nearest neighbor search on a current frame to search for point cloud frames within a range of 12 m, and arranging the point cloud frames according to distances in ascending order, wherein if an id number of the loop-closure frame is among first 10 numbers, that is, a first condition, and a timestamp of the loop-closure frame is more than 25 s from a current time point, that is, a second condition, the loop-closure frame is considered accurate and pose graph optimization is performed; while if the first condition and the second condition are not satisfied at the same time, the loop-closure frame is considered invalid and no processing is performed.

10. The SLAM method adapted to the external rotation 3D lidar device according to claim 8, wherein:
the pose graph optimization is performed by the following method:
solving loop-closure constraints formed after verification, projecting feature points of k point cloud frames near the loop-closure frame into a coordinate system at a time point of the loop-closure frame to obtain a local map in the coordinate system at this time point, and establishing point-to-line residual and point-to-plane residual equations to form a least squares optimization problem regarding relative pose transformation of the current frame in the coordinate system of the loop-closure frame:
$$min ( {\sum }_{k ∈ {ℒ}_{ε}} ρ ( {‖ {r}_{{ℒ}_{s}} ( {p}_{k} , {T}_{i}^{j} ) ‖}_{{p}^{{I}_{k}}}^{2} ) + {\sum }_{k ∈ {ℒ}_{ℋ}} ρ ( {‖ {r}_{{ℒ}_{ℋ}} ( {p}_{k} , {T}_{i}^{j} ) ‖}_{{p}^{{I}_{k}}}^{2} ) )$$
wherein [symbol] _{ε} and [symbol] respectively represent a number of local line features and a number of local plane features, r [symbol] _{_{ε}}(p_{K}, Tᵢ^{j}) represents point-to-line residual constraints on pose transformation between matched line feature points pₖ and two key frames i and j, [symbol] (p_{K}, Tᵢ^{j}) represents point-to-plane residual constraints on pose transformation between matched plane feature points pₖ and the two key frames i and j, and
$$ρ ( {‖ ‖}_{{p}^{{I}_{k}}}^{2} )$$
represents a distance variance; and
solving the least squares optimization problem by using a Levenberg-Marquardt (LM) method to obtain relative pose transformation between two loop-closure frames, updating a pose optimization result into an odometry output, and updating a map based on the pose optimization result to complete an optimization process.

11. The SLAM method adapted to the external rotation 3D lidar device according to claim 3, wherein:
in the step (2), the nearest neighbor motion compensation is performed by the following method:
calculating amounts of compensation required for the position, the velocity, and the attitude:
$${}^{{I}_{n}} {\check{p}}_{{I}_{j}} = {}^{{I}_{n}} {\check{p}}_{j - 1} + {}^{{I}_{n}} {\check{v}}_{{I}_{j}} Δ t$$
$${}^{{I}_{n}} {\check{v}}_{{I}_{j}} = {}^{{I}_{n}} {\check{v}}_{{I}_{j - 1}} + {}^{{I}_{n}} {\check{R}}_{{I}_{j}} ( {a}_{{f}_{m - 1}} - {\hat{b}}_{{a}_{n}} ) Δ t + {}^{{I}_{n}} {\hat{g}}_{n} Δ t$$
$${}^{{I}_{n}} {\check{R}}_{{I}_{j}} = {}^{{I}_{n}} {\check{R}}_{{I}_{j - 1}} Exp {( ( {\hat{b}}_{{ω}_{n}} - {ω}_{{f}_{m - 1}} ) Δ t )}^{T}$$
wherein n=1, 2, 3, . . . , K, K representing a total number of frames of the point cloud of the lidar, j=1, 2, 3, . . . , N, N representing a total number of sampling points in each of the frames of the point cloud of the lidar, ^{I}^{ₙ}p̌_{I}_{ⱼ₋₁},^{I}^{ₙ}p̌_{I}_{ⱼ} respectively represent the amounts of the compensation required for the position from a (j−1)^{th} and a j^{th} point to an end of an nth frame of the point cloud in an IMU coordinate system, and Δt represents a time difference from the j^{th} point to a nearest neighbor IMU frame; ^{I}^{ₙ}v̌_{I}_{ⱼ₋₁},^{I}^{ₙ}v̌_{I}_{ⱼ} respectively represent the amounts of the compensation required for the velocity from the (j−1)^{th} and the j^{th} point to the end of the nth frame of the point cloud in the IMU coordinate system, a_{f}_{ₘ₋₁} represents an acceleration input of an (m−1)^{th} frame of the IMU, ban represents an acceleration bias at the end of the n^{th} frame of the point cloud, and ^{I}^{ₙ}ĝₙ represents a gravity vector at the end of the n^{th} frame of the point cloud in the IMU coordinate system; ^{I}^{ₙ}Ř_{I}_{ⱼ₋₁},^{I}^{ₙ}Ř_{I}_{ⱼ} respectively represent the amounts of the compensation required for the attitude from the (j−1)^{th} and the j^{th} point to the end of the n^{th} frame of the point cloud in the IMU coordinate system, bon represents an angular velocity bias at the end of the n^{th} frame of the point cloud, and ω_{f}_{ₘ₋₁} represents an angular velocity input of the (m−1)^{th} frame of the IMU;
a compensated point being:
$${}^{{L}_{n}} {p}_{{h}_{j}} = {}^{I} {T}_{L}^{- 1} {}^{{I}_{n}} {\check{T}}_{{I}_{j}}^{I} {T}_{L}^{{L}_{j}} {p}_{{h}_{j}}$$
where ^{L}^{ₙ}pₕ_{ⱼ} represents a position of the j^{th} point after being compensated to the end of the n^{th} frame of the point cloud, that is, the compensated point, ^{I}^{ₙ}\hat{T}_{I}_{ⱼ} represents an amount of the compensation required from the j^{th} point to the end of the n^{th} frame of the point cloud in the IMU coordinate system, ^{I}T_{L} represents a transformation from a lidar coordinate system to the IMU coordinate system, and ^{L}^{ⱼ}Pₕ_{ⱼ} represents a position of the j^{th} point in the lidar coordinate system, that is, an uncompensated point.

12. The SLAM method adapted to the external rotation 3D lidar device according to claim 9, wherein:
the pose graph optimization is performed by the following method:
solving loop-closure constraints formed after verification, projecting feature points of k point cloud frames near the loop-closure frame into a coordinate system at a time point of the loop-closure frame to obtain a local map in the coordinate system at this time point, and establishing point-to-line residual and point-to-plane residual equations to form a least squares optimization problem regarding relative pose transformation of the current frame in the coordinate system of the loop-closure frame:
$$min ( {\sum }_{k ∈ {ℒ}_{ε}} ρ ( {‖ {r}_{{ℒ}_{s}} ( {p}_{k} , {T}_{i}^{j} ) ‖}_{{p}^{{I}_{k}}}^{2} ) + {\sum }_{k ∈ {ℒ}_{ℋ}} ρ ( {‖ {r}_{{ℒ}_{ℋ}} ( {p}_{k} , {T}_{i}^{j} ) ‖}_{{p}^{{I}_{k}}}^{2} ) )$$
wherein [symbol] _{ε} and [symbol] respectively represent a number of local line features and a number of local plane features, r [symbol] _{_{ε}}(pₖ, Tᵢ^{j}) represents point-to-line residual constraints on pose transformation between matched line feature points pₖ and two key frames i and j, [symbol] (pₖ, Tᵢ^{j}) represents point-to-plane residual constraints on pose transformation between matched plane feature points pₖ and the two key frames i and j, and
$$ρ ( {‖ ‖}_{{p}^{{I}_{k}}}^{2} )$$
represents a distance variance; and
solving the least squares optimization problem by using a Levenberg-Marquardt (LM) method to obtain relative pose transformation between two loop-closure frames, updating a pose optimization result into an odometry output, and updating a map based on the pose optimization result to complete an optimization process.
